(19) United States
(12) Patent Application Publication
(10) Pub. No.: US 2020/0043476 A1
(43) Pub. Date: Feb. 6, 2020

(54) ELECTRONIC DEVICE, CONTROL METHOD THEREFOR, AND NON-TRANSITORY COMPUTER READABLE RECORDING MEDIUM

(71) Applicant: Samsung Electronics Co., Ltd., Suown-si, Gyeonggi-do (KR)

(72) Inventor: Inchul HWANG, Seoul (KR)

(21) Appl. No.: 16/485,061

(22) PCT Filed: Jan. 8, 2018
(86) PCT No.: PCT/KR2018/000336

§ 371 Date: Aug. 9, 2019

(30) Foreign Application Priority Data
Feb. 21, 2017 (KR) 10-2017-0023121
Nov. 24, 2017 (KR) 10-2017-0157902

(51) Int. Cl. G10L 15/16; G10L 15/22; G10L 15/26; G06F 17/20; H04N 21/422; H04N 21/4788

(52) U.S. Cl. CPC G10L 15/16; G10L 15/22; G10L 15/26; G10L 2015/223; H04N 21/42203; H04N 21/4788; G06F 17/20

(57) ABSTRACT

The disclosure relates to an artificial intelligence (AI) system utilizing a machine learning algorithm such as deep learning, and applications thereof. In particular, a method for controlling an electronic device of the disclosure includes the steps of: receiving a user's voice; acquiring text data from the user's voice; determining a goal component and a parameter component from the acquired text data; determining, on the basis of the goal component and the parameter component, a task corresponding to the user's voice; if it is determined that the determined task is not executable, determining an alternative task to replace the task that was determined on the basis of at least one of the goal component and the parameter component; and providing a message for guiding the alternative task.

### TECHNICAL FIELD

The disclosure relates to an electronic device, a control method therefor, and a non-transitory computer readable recording medium and, more particularly, to an electronic device providing a guide for guiding an alternative task, when a task corresponding to a user's voice is not executable, a control method therefor, and a non-transitory computer readable recording medium.

### BACKGROUND ART

An artificial intelligence (AI) system is a computer system that implements human-level intelligence, and a system that a machine itself learns, judges, and becomes smart, unlike an existing rule-based smart system. The more the artificial intelligence systems are used, the more the recognition rate is improved. Therefore, a user's taste can be understood more accurately. As a result, existing rule-based smart systems are gradually being replaced by deep learning-based artificial intelligence systems.

Artificial intelligence technology is composed of machine learning (deep learning) and element technologies that utilize machine learning.

Machine learning is an algorithm technology that classifies or learns the characteristics of input data. Element technology is a technology that simulates functions, such as recognition and determination of human brain using machine learning algorithms, such as deep learning, composed of linguistic understanding, visual understanding, reasoning or prediction, knowledge representation, motion control, etc.

Various fields in which artificial intelligence technology is applied are as follows. Linguistic understanding is a technology for recognizing, applying or processing human language or characters and includes natural language processing, machine translation, dialogue system, question & answer, speech recognition or synthesis, and the like. Visual understanding is a technique for recognizing and processing objects as human vision, including object recognition, object tracking, image search, human recognition, scene understanding, spatial understanding, image enhancement, and the like. Inference prediction is a technique for judging and logically inferring and predicting information, including knowledge or probability based inference, optimization prediction, preference-based planning, and recommendation. Knowledge representation is a technology for automating human experience information into knowledge data, including knowledge building (data generation or classification) and knowledge management (data utilization). Motion control is a technique for controlling the autonomous running of the vehicle and the motion of the robot, including motion control (navigation, collision, driving), task control (behavior control), and the like.

In the meantime, improvement in a function of a mobile device, a voice recognition device, a home network hub device, a server and the like has led to increase in the number of users who use these devices. In particular, the electronic device may provide an intelligent assistant or a virtual personal assistant (VPA) function which may recognize a voice of a user, provide corresponding information, or execute a task.

The conventional intelligent assistant function provides only an error message to guide the occurrence of an error when the user's voice is analyzed and it is not interpreted that a task is executable. In particular, in a case where the task corresponding to the user's voice is determined but the determined task is not executable, if only an error message is provided, there may be a problem that it is not known what kind of user's voice should be inputted in order to execute a task intended by the user.

### DISCLOSURE

### Technical Problem

An object of the disclosure is to provide an electronic device, a control method therefor, and a non-transitory computer-readable recording medium for guiding an alternative task that may replace a task corresponding to a user's voice when the task corresponding to the user's voice is not executable.

### Technical Solution

According to an embodiment of the disclosure to achieve the above-described object, a control method of an electronic device includes receiving an input of a user's voice; acquiring text data from the user's voice and determining a goal component and a parameter component from the acquired text data; based on a basis of the goal component and the parameter component, determining a task corresponding to the user's voice; based on a determination that the determined task is not executable, determining the alternative task to replace the determined task on a basis of at least one of the goal component and the parameter component; and providing a message for guiding the alternative task.

According to an embodiment, an electronic device includes an inputter configured to receive an input of a user's voice; and a processor to acquire text data from the user's voice and determining a goal component and a parameter component from the acquired text data, determine, on a basis of the goal component and the parameter component, a task corresponding to the user's voice, based on a determination that the determined task is not executable, determine the alternative task to replace the determined task on a basis of at least one of the goal component and the parameter component, and provide a message for guiding the alternative task.

According to an embodiment, a control method of the electronic device of a non-transitory computer readable medium storing a computer program to execute a control method for an electronic device includes receiving an input of a user's voice; acquiring text data from the user's voice and determining a goal component and a parameter component from the acquired text data; determining, on a basis of the goal component and the parameter component, a task corresponding to the user's voice; based on a determination that the determined task is not executable, determining the alternative task to replace the determined task on a basis of at least one of the goal component and the parameter component; and providing a message for guiding the alternative task.

### Advantageous Effects

According to the embodiment of the disclosure as described above, by guiding the alternative task that may replace the unexecutable task, the intelligent assistant function may be used more easily and naturally by a user who uses the intelligent assistant function for the first time or even by a user who is not unfamiliar with the intelligent assistant function.

### BRIEF DESCRIPTION OF THE DRAWINGS

FIG. 1 is a block diagram schematically illustrating a configuration of an electronic device according to an embodiment;

FIG. 2 is a block diagram illustrating a configuration of an electronic device in detail according to an embodiment;

FIG. 3 is a block diagram illustrating a configuration for executing an intelligent assistant function according to an embodiment;

FIGS. 4A to 5 are views illustrating a message for guiding an alternative task according to an embodiment;

FIG. 6 is a view provided to describe a control method of an electronic device according to an embodiment;

FIG. 7 is a view illustrating an intelligent assistant system including a user terminal and a server for executing an intelligent assistant function according to another embodiment;

FIG. 8 is a sequence map provided to describe a control method of an intelligent assistant system according to an embodiment;

FIG. 9 is a block diagram illustrating a configuration of a processor according to an embodiment;

FIG. 10A is a block diagram illustrating a configuration of a data learning unit according to an embodiment; and

FIG. 10B is a block diagram illustrating a configuration of an alternative task determination unit according to an embodiment.

### BEST MODE

Hereinafter, the preferred embodiments will be described in detail with reference to the accompanying drawings. In the following description of the disclosure, detailed description of known functions and configurations incorporated herein will be omitted when it may unnecessarily obscure the gist of the disclosure. The terms used below are terms defined in consideration of the functions in this disclosure, which may vary depending on the user, operator or custom. Therefore, the definition should be based on the contents throughout this disclosure.

The terms such as “first,” “second,” and so on may be used to describe a variety of elements, but the elements should not be limited by these terms. The terms are used only for the purpose of distinguishing one element from another. For example, the first component may be referred to as the second component, and similarly, the second component may also be referred to as the first component. The term “and/or” includes any combination of a plurality of related items or any of a plurality of related items.

The terms used herein are used to illustrate the embodiments and are not intended to restrict and/or limit the embodiment. A singular expression includes a plural expression, unless otherwise specified. It is to be understood that the terms such as “comprise” or “consist of” are used herein to designate a presence of characteristic, number, operation, element, component, or a combination thereof, and not to preclude a presence or a possibility of adding one or more of other characteristics, numbers, operations, elements, components or a combination thereof.

In the various embodiments, a ‘module’ or a ‘unit’ may perform at least one function or operation, and be implemented as hardware or software, or as a combination of hardware and software. Further, except for the ‘module’ or the ‘unit’ that has to be implemented as particular hardware, a plurality of ‘modules’ or a plurality of ‘units’ may be integrated into at least one module and implemented as at least one processor.

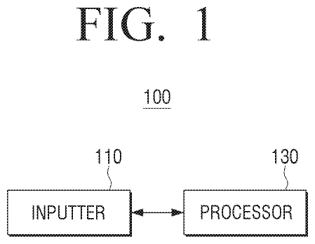

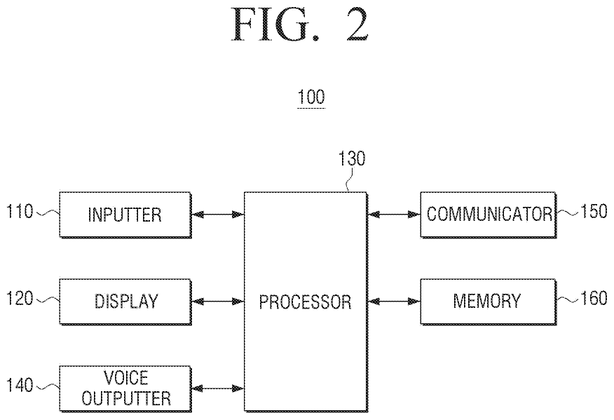

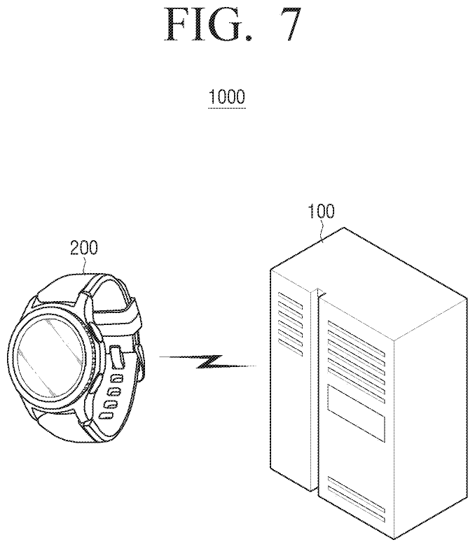

Hereinafter, the disclosure will be described in detail with reference to the accompanying drawings. FIG. 1 is a schematic block diagram for illustrating a configuration of an electronic device 100 according to an embodiment of the disclosure. As illustrated in FIG. 1, the electronic device 100 may provide an intelligent assistant service alone. When the electronic device 100 provides an intelligent assistant service alone, the electronic device 100 may be implemented as various electronic devices such as a smartphone, a tablet PC, a notebook PC, a desktop PC, a wearable device such as a smart watch, an electronic frame, a humanoid robot, an audio device, a smart TV, or the like. As another example, the electronic device 100 may be implemented as a server as shown in FIG. 7 to provide an intelligent assistant service to a user, in cooperation with an external user terminal 200.

As used herein, the term “intelligent assistant” refers to a software application to understand a user's language and perform instructions desired by the user by combining artificial intelligence technology and speech recognition technology. For example, the intelligent assistant may perform artificial intelligence functions such as machine learning, voice recognition, sentence analysis, and situational awareness, including deep learning. The intelligent assistant may learn the user's habits or patterns and provide a customized service needed for the individual. Examples of the intelligent agent include S voice and Bixby. The intelligent assistant may also be referred to as a virtual personal assistant, an interactive agent, or the like.

As illustrated in FIG. 1, the electronic device 100 includes an inputter 110 and a processor 130.

The inputter 110 receives a user's voice. At this time, the inputter 110 may be implemented as a microphone, and receive a user's voice through a microphone. In addition, the inputter 110 may receive a text corresponding to the user's voice as well as the user's voice.

The processor 130 may control overall tasks of the electronic device 100. To be specific, the processor 130 may acquire text data from a user's voice inputted through the inputter 110, and determine a goal component and a parameter component from the acquired text data. The processor 130 may determine a task corresponding to the user's voice based on the goal component and the parameter component. If it is determined that the determined task is not executable, the processor 130 may determine an alternative task for replacing the determined task on the basis of at least one of the goal component and the parameter component, and provide a message for guiding an alternative task.

More specifically, the processor 130 may acquire text data corresponding to the user's voice by analyzing the user's voice inputted through the inputter 110. In addition, the processor 130 may determine the goal component and the parameter component from the text data. At this time, the goal component may indicate the intention of the user through the user's voice, and the parameter component may indicate a specific content (for example, an application type, time, goal, etc.) related to the intended task of the user.

Then, the processor 130 may determine the task corresponding to the user's voice based on the determined goal component and the parameter component. At this time, the processor 130 may determine the type of the task corresponding to the user's voice based on the determined goal component, and determine the content of the task corresponding to the user's voice based on the parameter component.

When the task is determined, the processor 130 may determine whether the determined task is executable. Specifically, when the type of task is determined on the basis of the goal component, the processor 130 may determine whether the content of the task determined on the basis of the parameter component is executable.

If it is determined that the determined task is not executable, the processor 130 may determine an alternative task which may replace the task determined on the basis of at least one of the goal component and the parameter component.

Specifically, when it is determined that the determined task is not executable, the processor 130 may determine one of a plurality of alternative tasks which may replace the determined task as an alternative task, on a basis of the content of the task determined through the parameter component. At this time, the determined task and a plurality of alternative tasks may be matched to each other and stored.

Also, when it is determined that the content of the determined task is not executable, the processor 130 may determine an alternative task by inputting the content of the determined task to a learned alternative task determination model. At this time, the alternative task determination model is a model for recognizing an alternative task for replacing a specific task, and may be set up in advance.

In addition, the processor 130 may process and provide a message for guiding an alternative task in a natural language form. At this time, when the electronic device 100 is implemented in the form of a smartphone, the processor 130 may provide a message through a display. In addition, when the electronic device 100 is implemented as a server, the processor 130 may provide a message to an external user terminal.

FIG. 2 is a block diagram for illustrating a detailed configuration of the electronic device 100 according to an embodiment of the disclosure. Referring to FIG. 2, the electronic device 100 may include the inputter 110, a display 120, a processor 130, a voice outputter 140, a communicator 150, and a memory 160. In addition to the configurations illustrated in FIG. 2, the electronic device 100 may include various configurations such as an image receiver (not shown), an image processor (not shown), and a power unit (not shown). The electronic device 100 is not necessarily implemented to include all of the configurations shown in FIG. 2. For example, when the electronic device 100 is implemented as a server, the display 120 and the voice outputter 140 may not be provided.

The inputter 110 may receive a user's voice. In particular, the inputter 110 may include a voice inputter (for example, a microphone) for receiving a user's voice.

The voice inputter may receive a user's voice uttered by the user. For example, the voice inputter may be integrally formed on the upper side, the front side, and the side direction of the electronic device 100, or may be provided as a separate unit and connected to the electronic device 100 through a wired or wireless interface.

In addition, the voice inputter may be composed of a plurality of voice inputters to receive a voice at different positions to generate a plurality of voice signals. Using the plurality of voice signals, the electronic device 100 may generate a reinforced single voice signal in a pre-processing process prior to performing the voice recognition function. To be specific, the voice inputter includes a microphone, an analog-digital converter (ADC), an energy determination unit, a noise removing unit, and a voice signal generation unit.

The microphone receives an audio signal in an analog format including a user's voice. In addition, the ADC converts a multi-channel analog signal inputted from the microphone into a digital signal. In addition, the energy determination unit calculates energy of the converted digital signal to determine whether energy of the digital signal is greater than or equal to a predetermined value. When the energy of the digital signal is equal to or greater than a predetermined value, the energy determination unit transmits the inputted digital signal to a noise removing unit, and when the energy of the digital signal is less than a predetermined value, the energy determination unit does not output the inputted digital signal to the outside and waits for another input. Accordingly, the entire audio processing process is not activated by sound which is not a voice signal, and unnecessary power consumption may be prevented. When the digital signal inputted to the noise removing unit is inputted, the noise removing unit removes a noise component among the digital signals including the noise component and the user's voice component. At this time, the noise component may be a sudden noise which may occur in a home environment, and an air conditioner sound, a cleaner sound, a music sound, or the like may be included. The noise removing unit outputs the digital signal from which the noise component has been removed to a voice signal generation unit. The voice signal generation unit uses a localization/speaker tracking module to track a user's speech location existing within a 360 degree range based on the voice inputter to acquire direction information about the user's voice. In addition, the voice signal generation unit extracts a goal sound source existing within a range of 360 degrees based on the voice inputter by using direction information about the digital signal and the user's voice from which noise is removed, through a target spoken sound extraction module. When the voice inputter is wirelessly connected to the electronic device, the voice signal generation unit converts the user's voice into a user's voice signal of a format for transmitting the user's voice to the electronic device, and transmits a user's voice signal to a main body of the electronic device 100 by using a wireless interface.

In addition, the inputter 110 may receive various types of user commands, in addition to a user's voice. For example, the inputter 110 may receive a user command for selecting one of a plurality of candidate tasks displayed on the guide UI. In addition, the inputter 110 may be implemented as a button, a motion recognition device, a touch pad, or the like. In addition, when the inputter 110 is implemented as a touch pad, it may be implemented as a form of a touch screen in which the touch panel and the display 120 are combined with each other to form an inter-layer structure. The touch screen may detect a touch input position, an area, a pressure of a touch input, and the like.

The display 120 may display various guides, image contents, information, UI, or the like, provided by the electronic device 100. The display 120 may be implemented as a liquid crystal display (LCD), organic light emitting display (OLED), plasma display panel (PDP), or the like, and display various screens which may be provided through the electronic device 100.

The display 120 may provide an image corresponding to a voice determination result of the processor 130. For example, the display 120 may display a voice determination result of a user as a text. The display 120 may display a message guiding an alternative task.

The voice outputter 140 may output voice. For example, the voice outputter 140 may output not only various audio data but also a notification sound or a voice message. The electronic device 100 according to an embodiment may include the voice outputter 140 as one of the outputters for providing the interactive intelligent assistant function. By outputting the natural language processed voice message through the voice outputter 140, the electronic device 100 may provide the user with a user experience as if the user converses with the electronic device 100. The voice outputter 140 may be embedded in the electronic device 100 or may be implemented in the form of an output port such as a jack, or the like.

The communicator 150 communicates with an external device. For example, the external device may be implemented as another electronic device, a server, a cloud storage, a network, or the like. The communicator 150 may transmit a voice determination result to an external device, and receive the corresponding information from an external device. The communicator 150 may receive a language model to recognize voice and a learning model for determining the task from an external device.

As an embodiment, the communicator 150 may transmit the voice determination result to a server 200, and receive, from the server 200, a message for guiding a control signal for performing a corresponding task, or an alternative task.

For this purpose, the communicator 150 may include various communication modules such as a near field communication module (not shown), wireless communication module (not shown), or the like. The near field wireless communication module is a module for communicating with an external device located within a near filed, according to a near field wireless communication method such as Bluetooth, Zigbee, or the like. The wireless communication module is a module that is connected to an external network according to a wireless communication protocol such as Wi-Fi, WiFi direct, institute of electrical and electronics engineers (IEEE), and the like. In addition, the wireless communication module may further include a mobile communication module for performing communication by accessing a mobile communication network according to various mobile communication standards such as 3rd Generation (3G), 3rd Generation Partnership Project (3GPP), long term evolution (LTE), LTE Advanced (LTE-A), or the like.

The memory 160 may store various modules, software, and data for driving the electronic device 100. For example, the memory 160 may store an acoustic model (AM) and a language model (LM) which may be used to recognize a user's voice. In addition, a learned alternative task determining model may be stored in the memory 160 to determine an alternative task. In addition, a model for natural language generation (NLG) may be stored in the memory 160.

The memory 160 may store a program and data for configuring various screens to be displayed on the display 120. In addition, the memory 160 may store a program, an application, and data for executing a specific service.

The memory 160 may prestore various response messages corresponding to the user's voice as voice or text data. The electronic device 100 may read out at least one of the voice or text data corresponding to the received user's voice (in particular, a user control command) from the memory 160 may output to the display 120 or the voice outputter 140. Through this, the electronic device 100 may provide a user with a message which is simple or frequently used, without using a natural language generation model.

The memory 160 is a storage medium which stores various programs necessary for operating the electronic device 100, and may be implemented in a form of a flash memory, a Hard Disk Drive (HDD), a Solid State Drive (SSD), or the like. For example, the memory 160 may include a read-only memory (ROM) for storing a program to execute a task of the electronic device 100 and a random-access memory (RAM) for temporarily storing data according to execution of the task of the electronic device 100.

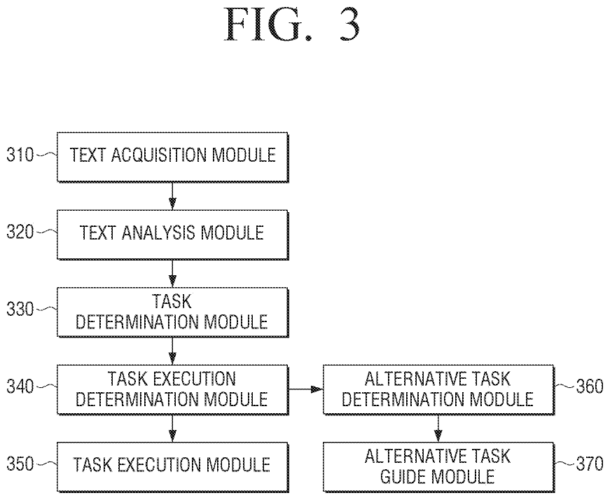

Meanwhile, the memory 160 may store a plurality of software modules for performing a task corresponding to the user's voice. In particular, the memory 160 may include a text acquisition module 310, a text analysis module 320, a task determination module 330, a task execution determination module 340, a task execution module 350, an alternative task determination module 360, and an alternative task guide module 370, as illustrated in FIG. 3.

The text acquisition module 310 acquires text data from a voice signal including a user's voice.

The text analysis module 320 analyzes the text data and determines the goal component and the parameter component of the user's voice.

The text determination module 330 determines a task corresponding to a user's voice based on the goal component and the parameter component. In particular, the text determination module 330 determines a type of task corresponding to a user's voice by using the goal component, and determine the content of the task corresponding to the user's voice using the parameter component.

The task execution determination module 340 determines whether the determined task is executable. More specifically, the task execution determination module 340 may determine whether the task is executable on the basis of the content of the task determined by using the parameter component. For example, the task execution determination module 340 may determine that the task is not executable, when the content of the task determined by using the parameter component indicates an unexecutable task, or some of the content of the task determined using the parameter component is missing.

When it is determined that the determined task is executable, the task execution module 350 executes the determined task.

If it is determined that the determined task is not executable, the alternative task determination module 360 may determine an alternative task that may replace the task determined using the goal component and the parameter component. At this time, the alternative task determination module 360 may determine the alternative task using the pre-stored alternative task matched with the determined task or the pre-learned alternative task determination model.

The alternative task guide module 370 provides a message for guiding the determined alternative task. At this time, the message for guiding the alternative task may be an auditory or visual format, and provided in a natural language format.

The processor 130 may control the above-described configurations of the electronic device 100. For example, the processor 130 may use a plurality of software modules stored in the memory 160 to determine an alternative task that may replace the task corresponding to the user's voice, and provide a message for guiding the determined alternative task.

The processor 130 may be implemented as a single CPU to perform a speech recognition task, a language understanding task, a dialog management task, an alternative task search task, a filtering task, a response generation task, or the like, or may be implemented as a plurality of processors and a dedicated processor that executes at least one task of a plurality of software modules stored in the memory. The processor 130 may perform speech recognition based on a conventional hidden Markov model (HMM) or may perform deep learning based speech recognition such as a Deep Neural Network (DNN).

In addition, the processor 130 may use the big data and the user-specific history data for voice recognition and alternative task determination. Through this, the processor 130 may personalize the voice recognition model and the alternative task determination model while using the alternative task determination model for determining the voice recognition model and the alternative task that have been learned using the big data.

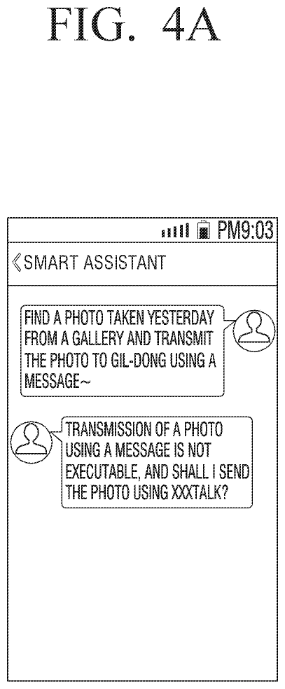

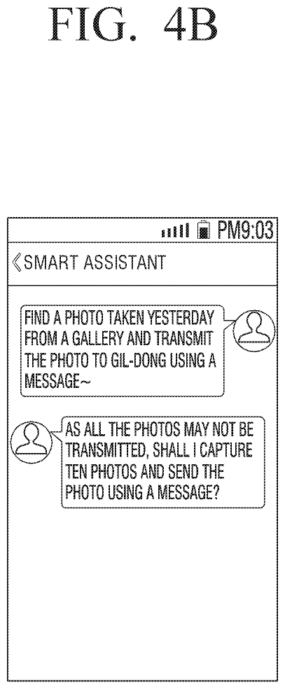

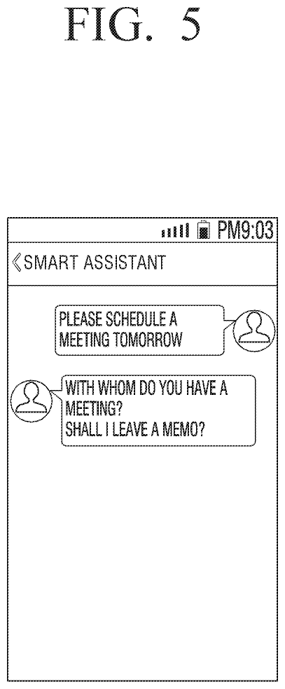

Hereinbelow, the disclosure will be described in a greater detail with reference to FIGS. 4A to 5.

As an embodiment, when a user's voice such as “find a photo taken yesterday from a photo gallery and transmit the photo to Gil-dong using a message” is inputted through the inputter 110, the processor 130 may acquire the text data from the user's voice by controlling the text acquisition module 310.

The processor 130 may determine the goal component and the parameter component by analyzing the acquired text data through the control of the text analysis module 320. For example, the processor 130 may control the text analysis module 320 to analyze the text data, “find a photo taken yesterday from a photo gallery and transmit the photo to Gil-dong using a message” to determine the goal component and the parameter component as follows.

<Goal: Transmission of a Photo>

<Para1 (Time): Yesterday, Para2 (AppName): Gallery Application, Para3(Person.to): Gil-dong, Para4 (AppName): Message Application>

The processor 130 may control the task determination module 330 to determine a task corresponding to the user's voice based on the goal component and the parameter component. Specifically, the processor 130 may control the task determination module 330 to determine that the type of task is “transmission of a photo”, and the content of the task is “find a photo taken yesterday from a photo gallery and transmit the photo using a message.”

The processor 130 may determine whether the determined task is executable by controlling the task execution determination module 340. When the determined task is executable, the processor 130 may control the task execution module 350 to execute the determined task or transmit a control signal corresponding to the determined task to the external device. For example, if it is possible to execute “find a photo taken yesterday from a gallery application and transmit the photo using a message,” the processor 130 may control the task execution module 350 to search for a picture taken yesterday in the gallery application, attach the photo to a message, and transmit the message to an external device corresponding to Gil-dong.

However, if the determined task is not executable, the processor 130 may control the alternative task determination module 360 and determine an alternative task capable of replacing a task determined on the basis of the goal component and the parameter component. For example, while the number of photos which may be transmitted using a message is five, if the number of photos taken yesterday which are found in the gallery application is ten, the processor 130 may determine that the determined task is not executable by controlling the task execution determination module 340.

The processor 130 may determine that the reason why the task is not executable is that ten photos may not be transmitted using a message by controlling the alternative task determination module 360 and determine whether there is an alternative task of a task which corresponds to the user's voice.

At this time, the alternative task may include a task which has the same type of the task corresponding to the user's voice but has a different content of task, or a task which includes a type and a content of a task different from the task corresponding to the user's voice.

For example, the processor 130 may control the alternative task determination module 360 and determine a task which has a same type of transmission of a photo, but a content of the task is transmission of a photo using another chatting application, instead of using a message, as an alternative task. That is, the processor 130 may control the alternative task determination module 360 and determine the alternative task that the type of the task is “transmission of a photo,” and the content of the task is “find a photo taken yesterday from a photo gallery and transmit the photo using a chatting application.”

As still another embodiment, the processor 130 may control the alternative task determination module 360 and determine a task having a different type of task as a capture screen transmission, not a photo transmission, as an alternative task. That is, the processor 130 may control the alternative task determination module 360 and determine an alternative task that the type of task is a “capture screen transmission”, and the content of the task is “find a photo taken yesterday from a photo gallery, capture a screen, and transmit the capture using a message.”

A plurality of alternative tasks corresponding to a specific task may be pre-stored. For example, the memory 160 may match and prestore “transmission of a capture screen”, “transmission of a message” or the like with “transmission of a photo” as an alternative task of “transmission of a photo”. At this time, the processor 130 may control the alternative task determination module 360 and determine, on the basis of the cause of the error, one of the at least one prestored alternative tasks as an alternative task of a task corresponding to the user's voice. For example, when a task corresponding to a user's voice is not executable, as the number of transmittable photos is exceeded, the processor 130 may control the alternative task determination module 360 and determines the “transmission of a capture screen” as an alternative task, and when a task corresponding to a user's voice is not executable, as the transmittable data is exceeded, the processor 130 may control the alternative task determination module 360 and determine “transmission of a message” as an alternative task. At this time, a cause of an error and an alternative task may also be matched and pre-stored.

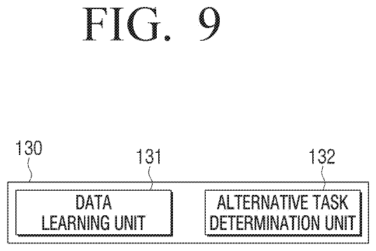

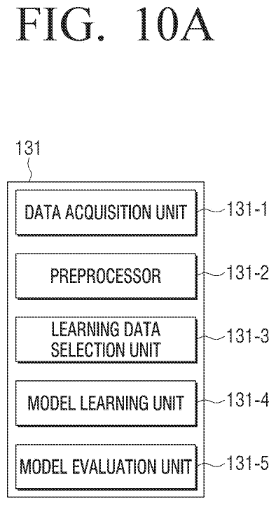

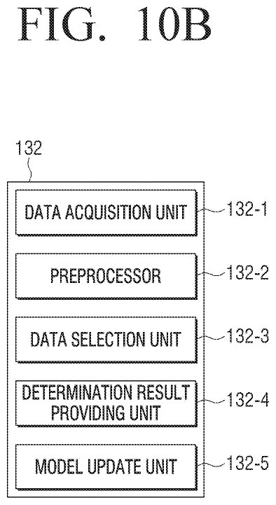

Alternatively, the processor 130 may control the alternative task determination module 360 to determine an alternative task for replacing the task corresponding to the user's voice using the pre-learned alternative task determination model. That is, the processor 130 may control the alternative task determination module 360 to determine an alternative task corresponding to the determined task by inputting the determined task to the alternative task determination model which is pre-learned by the user or others. The alternative task determination model will be described in detail with reference to FIGS. 9 to 10B.

When an alternative task is determined, the processor 130 may control the alternative task guide module 370 and provide a message for guiding the alternative task. At this time, the message for guiding the alternative task may include a message for guiding a cause of not executing the task corresponding to the user's voice and at least one of the alternative task. The processor 130 may control the alternative task guide module 370 to display a message for guiding the alternative task, and output a message in an audio format.

In addition, the processor 130 may provide a message for guiding the alternative task by controlling the alternative task guide module 370 in a natural language form. Specifically, in the case of the alternative task of which type of the task is “transmission of a photo” and a content of the task is “find a photo taken yesterday from a photo gallery application and transmit the photo using a chatting application,” the processor 130 may control the alternative task guide module 370 and display a message in a natural language of “transmission of a photo using a message is not executable, and shall I send the photo using xxxTalk?” on the display 120, as illustrated in FIG. 4A. Further, in the case of the alternative task of which the type of task is “transmission of a composite image”, and the content of the task is “find a photo taken yesterday from a gallery application and compose the photo into one image and transmit using a message,” the processor 130 may control the alternative task guide module 370 and display a message in a natural language “as all the photos may not be transmitted, shall I compose ten photos into one and send the photo using a message?” on the display 120, as illustrated in FIG. 4B.

At this time, the processor 130 may control the alternative task guide module 370 and provide a prestored message in a natural language format, but this is merely exemplary, and a message in a natural language format may be generated and provided using a language model for processing a natural language.

As another embodiment, when a user's voice “please schedule a meeting tomorrow” through the inputter 110, the processor 130 may control the text acquisition module 310 and acquire the text data from the user's voice.

In addition, the processor 130 may analyze the text data acquired by controlling the text analysis module 320 and determine the goal component and the parameter component. For example, the processor 130 may control the text analysis module 320 to analyze the text data “please make a schedule for tomorrow” and determine the goal component and the parameter component as shown below.

<Goal: Scheduling>

<Para1(Time): Tomorrow, Para2(AppName): Schedule Application, Para3(Person.to): Non>

The processor 130 may control the task determination module 330 and determine the task corresponding to the user's voice based on the goal component and the parameter component. To be specific, the processor 130 may control the task determination module 330 and determine that the type of the task is “scheduling” based on the goal component, and determine that the content of the task is “registering a tomorrow meeting to a schedule application.”

The processor 130 may control the task execution determination module 340 to determine whether the determined task is executable. If the determined task is not executable, the processor 130 may control the alternative task determination module 360 to determine the alternative task that may replace the determined task based on the goal component and the parameter component. For example, since there is no parameter component indicating whether a meeting is with whom, the processor 130 may control the task execution determination module 340 to determine that the determined task is not executable.

The processor 130 may control the alternative task determination module 360 to determine whether there is an alternative task for the task corresponding to the user's voice. For example, since there is no information as to whether the meeting is with whom, the processor 130 may control the alternative task determination module 360 to determine whether the alternative task has a different type of task of “leaving a memo” instead of “scheduling.” That is, the processor 130 may control the alternative task determination module 360 to determine the type of the task is “leaving a memo’, and the content of the task is “leaving a memo for a tomorrow meeting schedule.”

If the alternative task is determined, the processor 130 may control the alternative task guide module 370 to provide a message for guiding the alternative task. For example, in the case of the alternative task of which the type of the task is “leaving a memo” and the content of the task is “leaving a memo for a tomorrow meeting schedule”, the processor 130 may control the alternative task guide module 370 and display a message in a natural language format “With whom do you have a meeting? Shall I leave a memo?” on the display 120, as shown in FIG. 5.

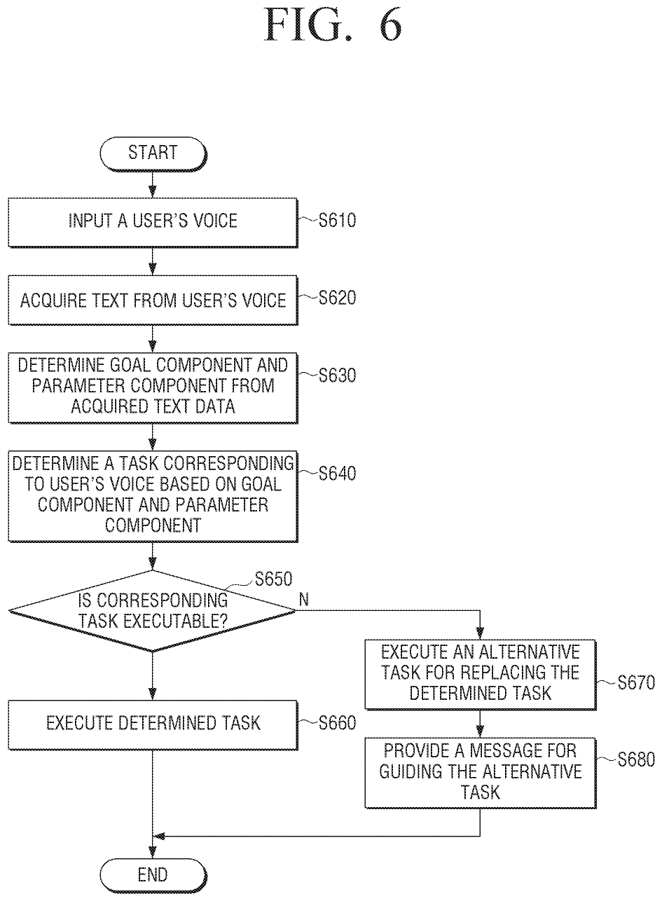

FIG. 6 is a flowchart provided to describe a control method of the electronic device 100 according to an embodiment.

First, the electronic device 100 receives an input of a user's voice in step S610.

The electronic device 100 acquires text data from the user's voice in step S620.

The electronic device 100 determines the goal component and the parameter component from the acquired text data in step S630.

Then, the electronic device 100 determines a task corresponding to the user's voice based on the goal component and the parameter component in step S640. At this time, the electronic device 100 may determine the type of task corresponding to the user's voice using the goal component, and determine the content of the task corresponding to the user's voice using the parameter component.

The electronic device 100 determines whether the determined task is executable in step S650.

If it is determined that the determined task is executable in step S650—Y, the electronic device 100 executes the determined task in step S660.

In the meantime, if it is determined that the determined task is not executable in step S650—N, the electronic device 100 determines an alternative task to replace the determined task in step S670. At this time, the electronic device 100 may determine one of a plurality of alternative tasks which are matched to the determined task and prestored, as the alternative task, and input the determined task to the alternative task determination model to determine the alternative task.

The electronic device 100 provides a message for guiding the alternative task in step S680. At this time, the electronic device 100 may process and provide a message for guiding the alternative task in a natural language format.

FIG. 7 is a view illustrating an intelligent assistant system including a user terminal and a server for executing an intelligent assistant function according to another embodiment. Referring to FIG. 7, an intelligent assistant system 1000 may include a user terminal 200 and a server 100. The electronic device 100 described above may be implemented as a server in FIG. 7.

The user terminal 200 may acquire the user's voice uttered by the user and transmit the user's voice to the external server 100. The server 100 may determine a task or an alternative task corresponding to the received user's voice, and transmit a message for guiding a control signal or an alternative task to the user terminal 200. As such, the user terminal 200 and the server 100 may interwork to provide an intelligent assistant service.

That is, the user terminal 200 may perform a role as an input and output device for receiving the user's voice and providing a message, and the server 100 may be implemented to process most of the intelligent agent service. In particular, as illustrated in FIG. 7, when the user terminal 200 is implemented as a small wearable device such as a smart watch and available resource is limited, the processes of determining an alternative task and generating a natural language, or the like, is executable by the server 100 having abundant resources.

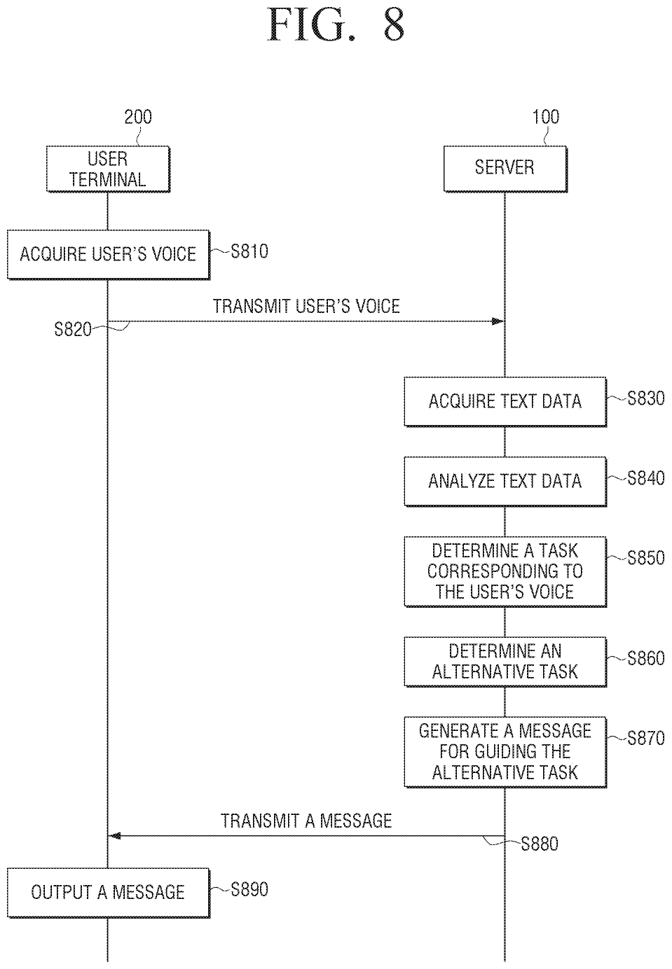

FIG. 8 is a sequence map provided to describe a control method of an intelligent assistant system according to an embodiment.

The user terminal 200 acquires the user's voice in step S810. The user terminal 200 may acquire the user's voice through a microphone provided in the user terminal 200 or connected to the user terminal 200.

The user terminal 200 transmits the user's voice to the external server 100 in step S820. To be specific, the user terminal 200 may transmit the voice signal corresponding to the user's voice to the external server 100.

The server 100 acquires the text data from the received user's voice in step S830.

The server 100 analyzes the text data in step S840, and determines the task corresponding to the user's voice in step S850. To be specific, the server 100 may determine the goal component and the parameter component from the text data, determine the type of the task corresponding to the user's voice from the goal component, and determine the content of the task corresponding to the user's voice from the parameter component.

When it is determined that the task corresponding to the user's voice is not executable, the server 100 determines the alternative task which may replace the task corresponding to the user's voice in step S860. At this time, the server 100 may determine one of the prestored alternative tasks as the alternative task, and determine the alternative task using the learned alternative task determination model.

The server 100 generates a message for guiding the alternative task in step S870. At this time, the server 100 may generate a message in a natural language format.

The server 100 transmits a message to the user terminal 200 in step S880, and the user terminal 200 outputs the received message in step S890.

According to an embodiment as described above, by guiding the alternative task for the task which is not executable, even a user who uses the intelligent assistant function for the first time or who is not familiar with the function may use the intelligent assistant function more easily and naturally.

FIG. 9 is a block diagram illustrating a configuration of the processor 130 according to an embodiment. Referring to FIG. 9, the processor 130 according to some embodiments may include a data learning unit 131 and an alternative task determination unit 132.

The data learning unit 131 may learn the criteria for determining the alternative task. The processor 130 may determine the alternative task which may replace the task corresponding to the user's voice by analyzing the input task according to the learned criteria. The data learning unit 131 may determine which data (or parameter component) to be used to determine the alternative task. The data learning unit 131 may learn the criteria for the alternative task by acquiring the data to be used for learning and applying the acquired data to the alternative task determination model which will be described later.

The alternative task determination unit 132 may determine the alternative task which may replace the task corresponding to the user's voice from the predetermined data using the pre-learned alternative task determination model. The alternative task determination unit 132 may acquire the predetermined data (for example, at least one of the goal component and the parameter component of the determined task) according to the predetermined criteria by learning, and use the alternative task determination model using the acquired data as an input value. In addition, the alternative task determination unit 132 may apply the input data to the alternative task determination model and acquire a result value for the alternative task. The alternative task determination unit 132 may update the alternative task determination model based on the user's feedback on an input value and an output value.

To be specific, at least one of the data learning unit 131 and the alternative task determination unit 132 may be implemented in one or a plurality of hardware chips and mounted in the electronic device 100. For example, at least one of the learning unit 131 and the alternative task determination unit 132 may be manufactured in the form of a dedicated hardware chip for artificial intelligence (AI) or a conventional general purpose processor (e.g., a CPU or an application processor) or a part of IP for a specific function, and may be mounted on the various electronic devices 100 described above.

In the embodiment of FIG. 9, it has been described that both the data learning unit 131 and the alternative task determination unit 132 are mounted in the electronic device 100, but the data learning unit 131 and the alternative task determination unit 132 may be mounted to separate devices. For example, one of the data learning unit 131 and the alternative task determination unit 132 may be included in the electronic device 100, and the other may be included in the user terminal 200. In addition, the data learning unit 131 and the alternative task determination unit 132 may be connected to each other by wire or without wire, and information on the alternative task determination model established by the data learning unit 131 may be provided to the alternative task determination unit 132, and the data inputted to the alternative task determination unit 132 may be provided to the learning unit 131 as the additional learning data.

At this time, at least one of the data learning unit 131 and the alternative task determination unit 132 may be implemented as a software module. When one of the data learning unit 131 and the alternative task determination unit 132 is implemented as a software module (or a program module including an instruction), the software module may be stored in a non-transitory computer readable media. In this case, the at least one software module may be provided by an operating system (OS) or by a predetermined application. Alternatively, some of the software modules may be provided by the OS, and some of the software modules may be provided by some applications.

FIG. 10A is a block diagram illustrating a configuration of the data learning unit 131 according to some embodiments. Referring to FIG. 10A, the data learning unit 131 according to some embodiments may include a data acquisition unit 131-1, preprocessor 131-2, learning data selection unit 131-3, a model learning unit 131-4, and a model evaluation unit 131-5.

The data acquisition unit 131-1 may acquire data necessary for determining an alternative task. In particular, the data acquisition unit 131-1 may acquire data for determining a task corresponding to the user's voice as learning data. For example, a signal corresponding to the user's voice inputted through the inputter 110, text data corresponding to the user's voice, and at least one of the goal component and the parameter component determined from the text data may be inputted.

The preprocessor 131-2 may preprocess the acquired data so that the acquired data may be used for learning to determine the alternative task. The preprocessor 131-2 may process the acquired data to a predetermined format so that the model learning unit 131-4 which will be described later may use the acquired data for learning for determination of the alternative task.

For example, the preprocessor 131-2 may extract a portion which is a target of recognition by the inputted user's voice. The preprocessor 131-2 may perform noise removal, feature extraction, or the like for the signal corresponding to the user's voice and perform conversion of a signal to text data.

As another example, the preprocessor 131-2 may generate the voice data to be suitable to voice recognition by a method of reinforcing some frequency components through analysis of the frequency components of the inputted user's voice and suppressing remaining frequency components.

The learning data selection unit 131-3 may select data required for learning from the preprocessed data. The selected data may be provided to the model learning unit 131-4. The learning data selection unit 131-3 may select data necessary for learning from among the preprocessed data according to a predetermined criterion for determining the alternative task. The learning data selection unit 131-3 may also select data according to a predetermined criterion by learning by the model learning unit 131-4, which will be described later. For example, the learning data selection unit 131-1 may select only the goal component and the parameter component from the input text data.

The model learning unit 131-4 may learn the criterion on how to determine the alternative task based on the learning data. In addition, the model learning unit 131-4 may learn the criterion regarding what kind of learning data needs to be used for determining the alternative task.

The model learning unit 131-4 may train the alternative task determination model used for alternative task determination using the learning data. In this case, the alternative operation determination model may be a model constructed in advance. For example, the alternative task determination model may be a model which has been established in advance by receiving the basic learning data. As another example, the alternative task determination model may be a pre-established model using the big data.

The alternative task determination model may be built in consideration of an applicable field of the recognition model, purpose of the learning, computer performance of a device, or the like. The alternative task determination model may be, for example, a model based on the neural network. For example, the alternative task determination model may include but is not limited to, Deep Neural Network (DNN), Recurrent Neural Network (RNN), Bidirectional Recurrent Deep Neural Network (BRDNN).

According to various embodiments, when there are a plurality of pre-built alternative task determination models, the model learning unit 131-4 may determine an alternative task determination model which has high relevance between the input learning data and the basic learning data as an alternative task determination model to be learned. In this case, the basic learning data may be pre-classified by data types, and the alternative task determination model may be pre-built by data types. For example, the basic learning data may be pre-classified based on various criteria such as a region where the learning data is generated, time when the learning data is generated, size of the learning data, genre of the learning data, a generator of the learning data, a type of an object in the learning data, or the like.

Further, the model learning unit 131-4 may train the alternative task determination model using, for example, a learning algorithm including an error back-propagation method or a gradient descent.

For example, the model learning unit 131-4 may train the alternative task determination model through supervised learning with the learning data as an input value. As another example, the model learning unit 131-4 may train the alternative task determination model through the unsupervised learning, which learns a type of necessary data by itself for determination of an alternative task without separate supervision, to identify the criterion for determination of the alternative task. As another example, the model learning unit 131-4 may train the alternative task determination model through reinforcement learning using feedback as to whether the result of determining the alternative task according to learning is correct.

When the alternative task determination model is trained, the model learning unit 131-4 may store the learned alternative task determination model. In this case, the model learning unit 131-4 may store the learned alternative task determination model in the memory 160 of the electronic device 100.

In this case, the memory 160 in which the learned alternative task determination model is stored may also store instructions or data associated with at least one other component of the electronic device 100. The memory 160 may also store software and/or programs. For example, the program may include a kernel, a middleware, an application programming interface (API) and/or an application program (or “application), or the like.

The model evaluation unit 131-5 may input evaluation data to the alternative task determination model and if the determination result which is outputted from the evaluation data does not satisfy the predetermined criterion, the model evaluation unit 131-5 may cause the model learning unit 131-4 to learn again. In this case, the evaluation data may be predetermined data for evaluating the alternative task determination model.

For example, among the determination results of the alternative task determination model which is trained for the evaluation data, if the number or ratio of the evaluation data of which the determination result is not accurate exceeds the predetermined threshold value, the model evaluation unit 131-5 may evaluate that the predetermined criteria is not satisfied. For example, if it is defined that the predetermined criterion is 2% of ratio, when the learned alternative task determination model outputs an incorrect determination result for the evaluation data exceeding 20 out of a total of 1000 evaluation data, the model evaluation unit 131-5 may evaluate that the trained alternative task determination model is not suitable.

In the meantime, when there are a plurality of learned alternative task determination models, the model evaluation unit 131-5 may evaluate whether each of the learned alternative task determination models satisfies a predetermined criterion, and determine a model which satisfies a predetermined criterion as a final alternative task determination model. In this case, when there are a plurality of models satisfying the predetermined criterion, the model evaluation unit 131-5 may determine any one or a predetermined number of models previously set in descending order of the evaluation score as the final alternative task determination model.

In the meantime, at least one of the data acquisition unit 131-1, the preprocessor 131-2, the learning data selection unit 131-3, the model learning unit 131-4, and the model evaluation unit 131-5 in the data learning unit 131 may be manufactured as at least one hardware chip and mounted in the electronic device. For example, at least one of the data acquisition unit 131-1, the preprocessor 131-2, the learning data selection unit 131-3, the model learning unit 131-4, and the model evaluation unit 131-5 may be manufactured as a dedicated hardware chip for AI, or a conventional general purpose processor (e.g., a CPU or an application processor) or a part of IP for a specific function, and may be mounted on the various electronic devices 100 described above.

The data acquisition unit 131-1, the preprocessor 131-2, the learning data selection unit 131-3, the model learning unit 131-4, and the model evaluation unit 131-5 may be mounted in one electronic device, or separately mounted in individual electronic devices. For example, a part of the data acquisition unit 131-1, the preprocessor 131-2, the learning data selection unit 131-3, the model learning unit 131-4, and the model evaluation unit 131-5 may be included in the electronic device 100, and a part of the others may be included in the server 200.

In the meantime, at least one of the data acquisition unit 131-1, the preprocessor 131-2, the learning data selection unit 131-3, the model learning unit 131-4, and the model evaluation unit 131-5 may be implemented as a software module. When at least one of the data acquisition unit 131-1, the preprocessor 131-2, the learning data selection unit 131-3, the model learning unit 131-4, and the model evaluation unit 131-5 is implemented as a software module (or a program module including instructions), the software modules may be stored on non-transitory computer-readable recording media. The at least one software module may be provided by an operating system (OS) or by a predetermined application. Alternatively, at least one of the at least one software module may be provided by the OS and the rest may be provided by a predetermined application.

FIG. 10 is a block diagram of the alternative task determination unit 132 according to some embodiments. Referring to FIG. 10B, the alternative task determination unit 132 according to some embodiments may include a data acquisition unit 132-1, a preprocessor 132-2, a learning data selection unit 132-3, a determination result providing unit 132-4, and a model update unit 132-5.

The data acquisition unit 132-1 may acquire the data required for determination of an alternative task, and the preprocessor 132-2 may preprocess the acquired data so that the acquired data may be used for determination of the alternative task. The preprocessor 132-2 may process the acquired data to a predetermined format so that the determination result providing unit 132-4 which will be described later may use the acquired data for the determination of the alternative task.

The data selection unit 132-3 may select the data which is required for determination of the alternative task from among the preprocessed data. The selected data may be provided to the determination result providing unit 132-4. The data selection unit 132-3 may select a part or whole of the preprocessed data, in accordance with the predetermined criterion for determination of the alternative task. Alternatively, the data selection unit 132-3 may select the data according to the predetermined criterion by learning of a model learning unit 142-4 to be described later.

The determination result providing unit 132-4 may apply the selected data to the alternative task determination model to determine an alternative task that may replace a task corresponding to the user's voice. The determination result providing unit 132-4 may apply the selected data to the alternative task determination model by using the data selected by the data selection unit 132-3 as an input value. Alternatively, the determination result may be determined by the alternative task determination model. For example, the determination result providing unit 132-4 may input the data for determining the task corresponding to the user's voice to the alternative task determination model and determine a task which may replace the task corresponding to the user's voice.

The model update unit 132-5 may cause the alternative task determination model to be updated based on the evaluation for the evaluation result provided by the determination result providing unit 132-4. For example, the model update unit 132-5 may provide the determination result provided by the determination result providing unit 132-4 to the model learning unit 131-4 so that the model learning unit 131-4 may update the alternative task determination model.

In the meantime, at least one of the data acquisition unit 132-1, the preprocessor 132-2, the data selection unit 132-3, the determination result providing unit 132-4, and the model update unit 132-5 may be manufactured as at least one hardware chip and mounted in the electronic device. For example, at least one of the data acquisition unit 132-1, the preprocessor 132-2, the data selection unit 132-3, the determination result providing unit 132-4, and the model update unit 132-5 may be manufactured as a dedicated hardware chip for AI, or a conventional general purpose processor (e.g., a CPU or an application processor) or a part of IP for a specific function, and may be mounted on the various electronic devices 100 described above.

The data acquisition unit 132-1, the preprocessor 132-2, the data selection unit 132-3, the determination result providing unit 132-4, and the model update unit 132-5 may be mounted in one electronic device or mounted in individual electronic devices, respectively. For example, some of the data acquisition unit 132-1, the preprocessor 132-2, the data selection unit 132-3, the determination result providing unit 132-4, and the model update unit 132-5 may be included in the electronic device 100, and others may be included in a server which is linked to the electronic device 100.

In the meantime, at least one of the data acquisition unit 132-1, the preprocessor 132-2, the data selection unit 132-3, the determination result providing unit 132-4, and the model update unit 132-5 may be implemented as a software module. When at least one of the data acquisition unit 132-1, the preprocessor 132-2, the data selection unit 132-3, the determination result providing unit 132-4, and the model update unit 132-5 is implemented as a software module (or a program module), the software module may be stored in a non-transitory computer readable media. In this case, the at least one software module may be provided by an operating system (OS) or by a predetermined application. Alternatively, some of the software modules may be provided by the OS, and some of the software modules may be provided by a predetermined application.

The methods described above may be implemented in a form of program instructions that is executable through various computer means and may be recorded in a computer-readable recording medium. The computer-readable recording medium may include a program instruction, a data file, a data structure or the like, alone or a combination thereof. The program instructions recorded in the computer-readable recording medium may be especially designed and configured for the disclosure or be known to those skilled in a field of computer software. Examples of the computer-readable recording medium may include a magnetic medium such as a hard disk, a floppy disk, and a magnetic tape; an optical medium such as a compact disk read only memory (CD-ROM) or a digital versatile disk (DVD); a magneto-optical medium such as a floptical disk; and a hardware device specially configured to store and execute program commands, such as a read-only memory (ROM), a random access memory (RAM), a flash memory, or the like. Examples of the program instructions include a high-level language code capable of being executed by a computer using an interpreter, or the like, as well as a machine language code made by a compiler. The abovementioned hardware device may be constituted to be operated as one or more software modules to perform an operation according to the disclosure, and vice versa.

Although the disclosure has been described with reference to the embodiments and the accompanying drawings, the disclosure is not limited to the above-mentioned embodiments, but may be variously modified and altered from the above description by those skilled in the art to which the disclosure pertains. Therefore, the scope of the disclosure is not construed as being limited to the embodiments described above, but should be defined by the following claims as well as equivalents thereto.

What is claimed is:

1. A control method of an electronic device, the method comprising:
receiving an input of a user's voice;
acquiring text data from the user's voice and determining a goal component and a parameter component from the acquired text data;
based on a basis of the goal component and the parameter component, determining a task corresponding to the user's voice;
based on a determination that the determined task is not executable, determining the alternative task to replace the determined task on a basis of at least one of the goal component and the parameter component; and
providing a message for guiding the alternative task.

2. The method of claim 1,
wherein the determining a task corresponding to the user's voice comprises determining a type of a task corresponding to the user's voice based on a basis of the determined goal component, and determining a content of a task corresponding to the user's voice on a basis of the parameter component.

3. The method of claim 2, further comprising:
based on the type of the task being determined on a basis of the goal component, determining whether a content of the determined task is executable on a basis of the parameter component.

4. The method of claim 3,
wherein the determining the alternative task comprises, based on a determination that the content of the determined task is not executable, determining one of a plurality of alternative tasks which are capable of replacing the determined task as an alternative task, on a basis of the content of the determined task.

5. The method of claim 4,
wherein the determined task and the plurality of alternative tasks are matched to each other and prestored.

6. The method of claim 3,
wherein the determining the alternative task comprises, based on a determination that the content of the determined task is not executable, determining an alternative task by inputting the content of the determined task to a learned alternative task determination model.

7. The method of claim 1,
wherein a message for guiding the alternative task is processed in a natural language format.

8. An electronic device, comprising:
an inputter configured to receive an input of a user's voice; and
a processor configured to:
acquire text data from the user's voice and determining a goal component and a parameter component from the acquired text data,
based on a basis of the goal component and the parameter component, determine a task corresponding to the user's voice,
based on a determination that the determined task is not executable, determine the alternative task to replace the determined task on a basis of at least one of the goal component and the parameter component, and
provide a message for guiding the alternative task.

9. The electronic device of claim 1,
wherein the processor determines a type of a task corresponding to the user's voice based on a basis of the determined goal component, and determines a content of a task corresponding to the user's voice on a basis of the parameter component.

10. The electronic device of claim 9,
wherein the processor, based on the type of the task being determined on a basis of the goal component, determines whether a content of the determined task is executable on a basis of the parameter component.

11. The electronic device of claim 10,
wherein the processor, based on a determination that the content of the determined task is not executable, determines one of a plurality of alternative tasks which are capable of replacing the determined task as an alternative task, on a basis of the content of the determined task.

12. The electronic device of claim 11, further comprising:
a memory which matches and stores the determined task and the plurality of alternative tasks.

13. The electronic device of claim 10,
wherein the processor, based on a determination that the content of the determined task is not executable, determines an alternative task by inputting the content of the determined task to a learned alternative task determination model.

14. The electronic device of claim 8,
wherein the processor processes and provides a message for guiding the alternative task in a natural language format.

15. A non-transitory computer readable medium storing a computer program to execute a control method for an electronic device,
wherein the control method for the electronic device comprises:
receiving an input of a user's voice;
acquiring text data from the user's voice and determining a goal component and a parameter component from the acquired text data;
based on a basis of the goal component and the parameter component, determining a task corresponding to the user's voice;
based on a determination that the determined task is not executable, determining the alternative task to replace the determined task on a basis of at least one of the goal component and the parameter component; and
providing a message for guiding the alternative task.
